(19) United States
(12) Patent Application Publication
(10) Pub. No.: US 2009/0091171 A1
(43) Pub. Date: Apr. 9, 2009

(54) Moving Seat for Vehicles

(76) Inventor: Javier Valverde Fernandez, (VIGO) Pontevedra (ES)

Correspondence Address: WENDEROTH, LIND & PONACK, L.L.P., 2033 K STREET N. W., SUITE 800, WASHINGTON, DC, 20006-1021, US

(21) Appl. No.: 12/224,128

(22) PCT Filed: Feb. 20, 2007
(86) PCT No.: PCT/ES2007/000094

§ 371 Date: Dec. 2, 2008

(30) Foreign Application Priority Data
Feb. 20, 2006 (ES) U200600442

(51) Int. Cl. B60N 2/005; B60N 2/42; B60N 2/10

(52) U.S. Cl. 297/325; 296/65.01

(57) ABSTRACT

The invention relates to a moving seat for vehicles, which is characterised in that it is mounted to a gimbal suspension support with one or two shafts, whereby the centre of gravity of the seat and the passenger is located below the suspension shafts. The invention also includes dampers and devices for blocking, delimiting or minimizing the sharpness of the movements.

### OBJECT OF THE INVENTION

The present invention as expressed by the title of this description refers to a moving seat for vehicles intended for the auto industry and which object is to provide the vehicle with a moving seat that decreases the fatigue and discomfort caused by the forces affecting the driver and/or passenger's bodies during speed, tilt and path shifts, as well as providing greater safety conditions during possible accidental impacts.

### BACKGROUND OF THE INVENTION

Vehicle seats, from the first automobiles to the modern vehicles of today, are assembled to the chassis of the vehicle in a fixed manner, in such a way that the movements of the seat and the passenger are the same as those of the vehicle, which causes fatigue and discomfort to the vehicle's occupants.

### DESCRIPTION OF THE INVENTION

In order to attain the objectives and avoid said drawbacks, the present invention proposes a moving seat for vehicles characterised in that it is a seat that follows the movements of the passenger's gravity centre, tilting conveniently into it and concentrating on the seat's base the static and dynamic forces of the whole set.

The seat is also characterised in that it is mounted on a moving support or gimbal suspension having one or two perpendicular shafts (forward-backwards, left-right), with the centre of gravity of the seat and passenger located below the suspension shafts. It is further equipped with dampers and devices for blocking, delimiting or minimising the sharpness of the movements.

Another characteristic of the invention is that it is mounted on a moving support equipped with hydraulic devices that move the seat responding to gravity centre movement sensors.

The next section, which is an integrated part of this descriptive report, is intended to facilitate the understanding of the information it contains by including figures that are intended for illustration and not for limiting purposes of the object of the invention.

### BRIEF DESCRIPTION OF THE DRAWINGS

FIG. 1.—Shows a schematic plan view of a vehicle equipped with the moving seat for vehicles object of the present invention.

FIG. 2.—Shows a lateral view of the same vehicle represented in FIG. 1.

FIG. 3.—Shows a front frontal view of the moving seat for vehicles object of the invention.

FIG. 4.—Shows a rear frontal view of the moving seat for vehicles object of the invention.

FIGS. 5 to 8.—Show different schematic views of the moving seat for vehicles object of the invention set in different positions that show the results of the present invention.

FIGS. 9 to 11.—Show different schematic views of the moving seat for vehicles object of the invention showing a seat equipped with a gimbal suspension of one or two shafts.

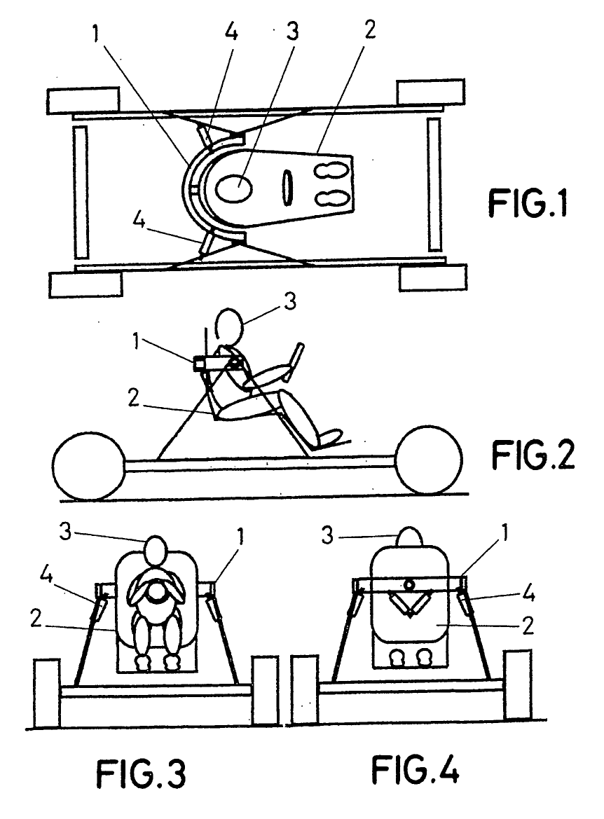

### DESCRIPTION OF THE PREFERRED EMBODIMENT

Considering the number sequence of the figures described in the previous section, the invention comprises a seat suspended on a gimbal suspension 1,1′, two concentric circles or semicircles, forward-backward 5 and left-right 6 arranged at right angles to the shaft (FIG. 1) so the centre of gravity of the seat 2 and the passenger 3 is located below the suspension shafts, allowing it to oscillate in response to the forces affecting it.

It is also provided with damper elements 4 for delimiting or minimising the speed of said movements so the seat 2 and passenger 3 set oscillates with a rocking motion as it adjusts its centre of gravity in response to the vehicle's movement.

Other embodiments of the present invention intended for the same function and achieving the same result may comprise the combination of technical, mechanical, electromechanical, hydraulic, pneumatic, computerised or other means. The combination of movement or force sensors and response devices to achieve the same results may be countless.

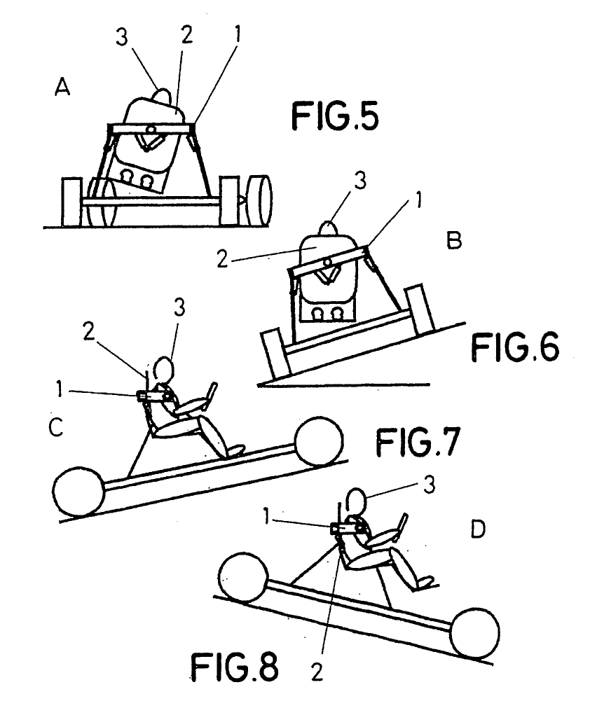

FIG. 5 shows a rear view of a running vehicle describing a right curve on a levelled road. In this particular case the centre of gravity moves to the left in response to the centrifugal force tilting the seat and passenger set.

FIG. 6 shows also a rear view of the vehicle stopped on a banked road.

FIG. 7 shows a side view of the vehicle going up hill.

FIG. 8 shows also a side view of the vehicle going down hill.

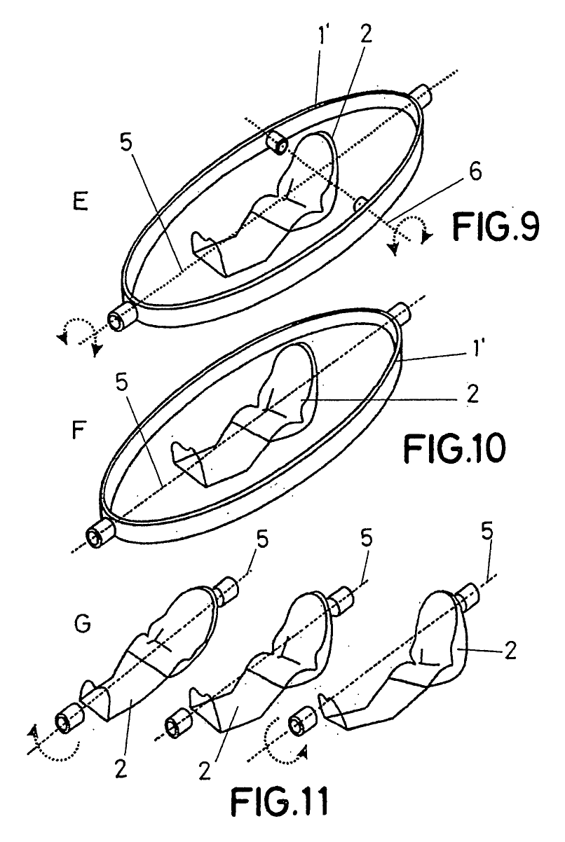

FIG. 9 shows the seat inside a 2-shaft (forward-backwards, left-right) gimbal suspension assembly.

FIG. 10 shows a seat inside a 1 longitudinal shaft (forward-backwards) 5 gimbal suspension assembly.

Lastly, FIG. 11 shows the vehicle seat tilted to the left, in a centered position, and tilted to the right, assembled on a 1 transversal shaft (forward-backwards) 6 gimbal suspension.

1. Moving seat for vehicles wherein the seat is mounted on a moving assembly or a gimbal suspension of one or two shafts (forward-backward, left-right), in which the centre of gravity of the seat and the passenger is located below the suspension shafts, being equipped with dampers and devices for blocking, delimiting or minimising the sharpness of movements.

2. Moving seat for vehicles according to claim 1, wherein the seat is mounted on a moving assembly equipped with hydraulic devices that move the seat in response to information sent by sensors detecting movements of the centre of gravity.
